(19) United States
(12) Patent Application Publication
(10) Pub. No.: US 2014/0093435 A1
(43) Pub. Date: Apr. 3, 2014

(54) Device for Removing Volatile Particles from Sample Gas

(71) Applicants: Barouch GIECHASKIEL, Graz (AT); Alexander Bergmann, Graz (AT)

(72) Inventors: Barouch GIECHASKIEL, Graz (AT); Alexander Bergmann, Graz (AT)

(73) Assignee: AVL LIST GMBH

(21) Appl. No.: 13/734,038

(22) Filed: Jan. 4, 2013

(30) Foreign Application Priority Data
Sep. 28, 2012 (AT) GM 386/2012

(51) Int. Cl. B01D 53/94

(52) U.S. Cl. CPC B01D 53/9477
USPC 422/170; 422/169

(57) ABSTRACT

For a particularly compact device for removing the volatile particles from a sample gas with a simple design and a maximum of energy efficiency it is suggested to provide for a removal device (3) with an evaporator (7) and a catalyst (8), with the catalyst (8) being installed downstream of the evaporator (7), and furthermore to adjust the standard volumetric flow rate (\dot{V}) of the undiluted sample gas to a given catalytic efficiency of catalyst (8) by means of a flow limiting device (5).

The invention at hand concerns a device for the removal of volatile particles from an undiluted sample gas loaded with solid particles and volatile particles.

Devices of the above-mentioned type and the procedures for which they are applied are known especially in connection with the characterization and measurement of aerosols in the exhaust gas of internal combustion engines and are at least partly also the object of national as well as of regional and international test specifications, standards and the like already. It is well known that exhaust gas of internal combustion engines, especially of diesel engines, does not only contain classic aerosols (in the sense of volatile suspended particles), but a mix of solid and volatile suspended particles in a carrier gas, the harmfulness of the exhaust gas being almost exclusively attributed to the solid particles. Therefore the concentration of solid particles in the exhaust gas of an internal combustion engine is subject to exacting regulations and proof of compliance with these regulations has to be furnished by means of a suitable measuring device. For this purpose, before the ultimate measurement the volatile particles that are not relevant have to be eliminated from the exhaust gas to be analyzed; for this, different configurations are known.

EP 2 264 423 A2, for example, describes a configuration where the sample flow is consecutively diluted, heated and, once again, diluted. In the pre-diluter, the concentration of solid particles as well as of volatile aerosols in the sample flow is reduced. Downstream, in the heated evaporator, the volatile substances are converted into the vapor phase, and by setting a suitable pre-dilution the concentration of the volatile aerosols can be reduced so far that after the evaporator the vapor pressure of these substances is low enough so that they no longer condense when they are cooled down subsequently, resulting in the sample flow, which is to be cooled down subsequently, containing only the solid particles to be measured. Cooling down is realized by means of a secondary diluter. Such a configuration is also known in the art as a volatile particle remover (VPR).

In addition to that, thermal denuders (diffusion separators for the separation of gases) and catalysts (so-called catalytic stripper) are known for the removal of volatile particles from the sample flow, see for example “Evaluation of thermal denuder and catalytic stripper methods for solid particle measurements”, J. Swanson, et al., Journal of Aerosol Science, 41 (2012), pp. 1313-1322. The thermal denuder is based on the fact that the aerosol is heated up and that the evaporated material is adsorbed by a carrier material (typically activated carbon). Here, the catalyst comprises an oxidation catalyst and a sulfur trap through which a diluted sample flow is passed. See also “Nano particle formation in the exhaust of internal combustion engines”, M. Stenitzer, Diploma thesis at Vienna Technical University, 2003.

U.S. Pat. No. 6,796,165 B2 describes another device for measuring the concentration of solid particles contained in an aerosol, which removes the volatile components from the sample flow by means of a catalyst. Undiluted sample gas can also be supplied to the catalyst. Also, it allows for determining the mass and the size of the solid particles by providing suitable sensor devices in parallel after a secondary diluter. A sufficient mass flow must be provided to supply the individual sensors. For this reason, a secondary diluter has to be installed after the catalyst to cool the sample gas down to a specific temperature before the gas can be supplied to the sensor devices. In “Real time measurement of volatile and solid exhaust particles using a catalytic stripper”, I. S. Abdul-Khalek, et al., SAE Paper 950236, 1995, a cooling coil for cooling down the sample gases is provided after the catalyst and before the particle counter.

All known configurations entail a great degree of complexity and need a large number of individual components, resulting in a corresponding size of the overall arrangement.

It is therefore an object of the present invention to provide a device for removing volatile particles from a sample gas, the device being simply designed, energy-efficient and as compact as possible.

This object is solved according to the invention by providing a removal device comprising an evaporator and a catalyst, the catalyst being arranged downstream of the evaporator, and to furthermore provide a flow limiting device which adjusts the standard volumetric flow rate of the undiluted sample gas to a predefined catalytic efficiency of the catalyst. Accordingly, when the standard volumetric flow rate is reduced by the removal device so that the catalytic efficiency of the catalyst suffices to remove the volatile particles from the sample gas in the requested extent, no diluter is necessary before the catalyst at all. At the same time, however, no diluter is necessary after the catalyst for cooling the sample gas either because due to the limited standard volumetric flow rate efficient cooling of the sample gas before it enters the sensor device is possible even without dilution.

When the evaporator and the catalyst are arranged in direct succession of each other, the removal device can have a more compact design. At the same time, undesired particle deposits in the sample line between the evaporator and the catalyst are averted.

In an advantageous embodiment, the configuration of the flow limiting device limits the standard volumetric flow rate to 1 to 5 l/min.

Preferably the catalyst is designed as an oxidation catalyst or a sulfur trap or as a combination of these. In that way, the volatile particles can be removed from the sample gas in an especially efficient manner.

When the oxidation catalyst and the sulfur trap are arranged in an arbitrary order in direct succession of each other particle deposits in a connecting line are prevented on the one hand and cooling down of the sample gas below the necessary start-up temperature of the catalyst is safely prevented on the other hand.

Due to the particularly compact size and the energy efficiency of the device according to the invention, it can also be used for the determination of a characteristic value of a gas flow loaded with particles in mobile applications, e.g. moving vehicles, which makes the device particularly flexible.

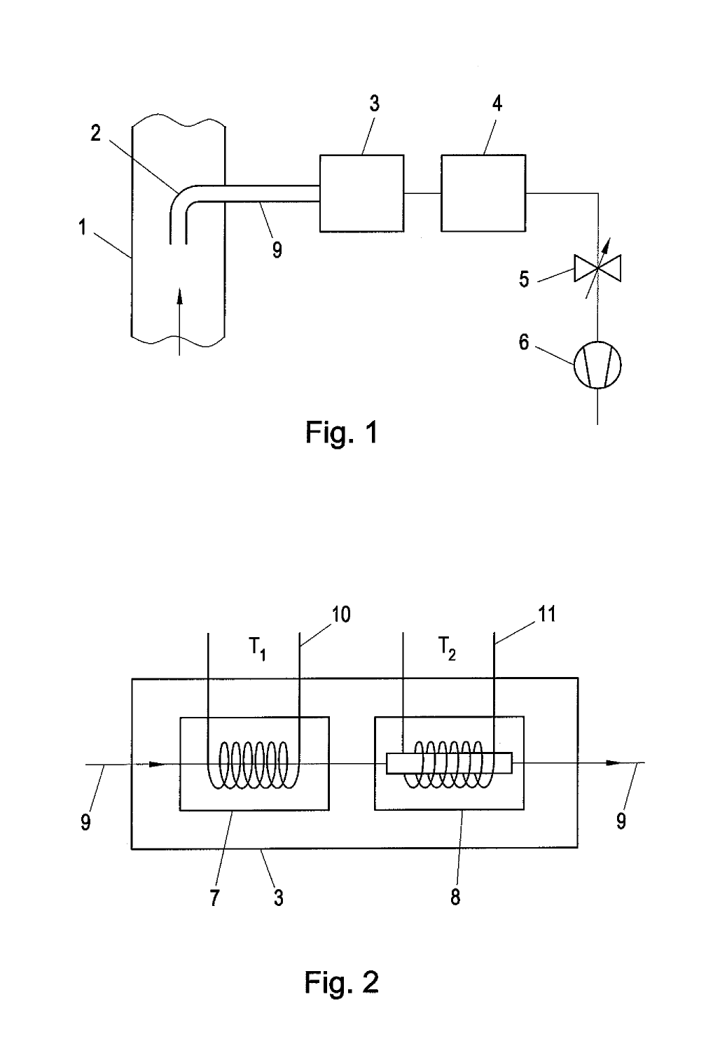

The invention at hand is explained in more detail below with reference to FIGS. 1 to 4, which exemplary, schematically and in a non-restrictive manner show advantageous configurations of the invention.

FIG. 1 shows an arrangement for the determination of the characteristic values of a gas flow loaded with particles,

FIG. 2 shows an illustration of the removal device for removing volatile particles from the sample gas,

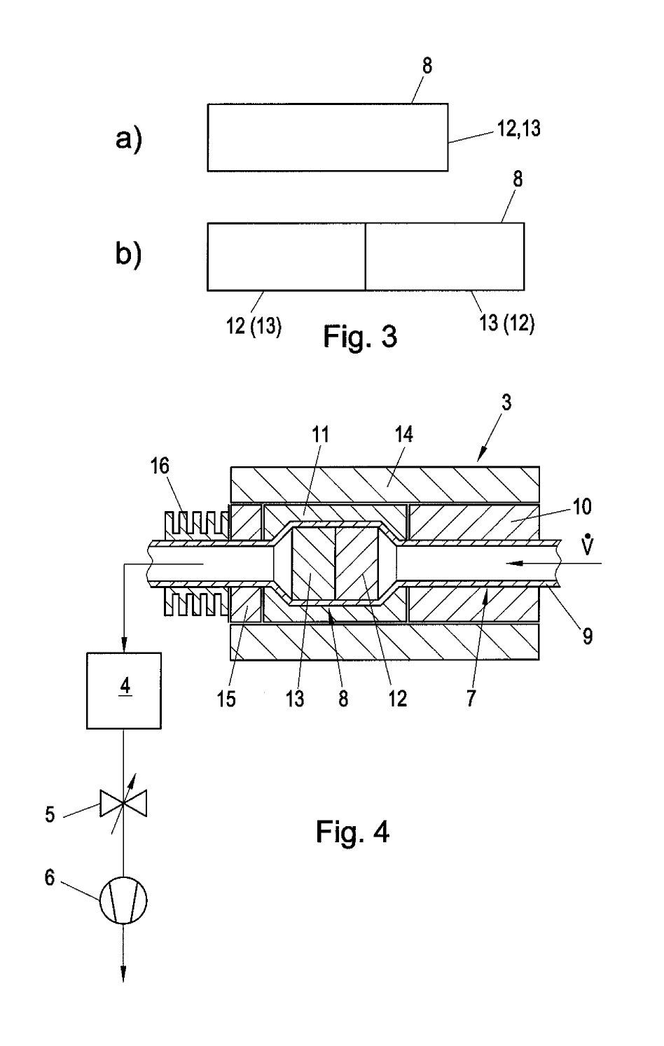

FIG. 3 shows possible configurations of the catalyst and

FIG. 4 shows a particularly compact configuration of the removal device.

FIG. 1 shows a basic configuration for the determination of the characteristic values of a gas flow loaded with particles, e.g. the concentration of solid particles, the particle size distribution of solid particles, the mass of solid particles, their specific surface, etc. The gas flow (indicated by the arrow), e.g. exhaust gas from an internal combustion engine, flows through line 1 and is an aerosol comprising solid and volatile suspended particles. By means of a sample pipe 2 a sample gas flow is diverted as a partial flow of the gas flow and directed to sample line 9 via removal device 3. In removal device 3, the volatile particles are removed from the sample gas flow. The sample gas flow may then be passed on to a sensor device 4 for measuring specific characteristic values of the sample gas flow. Here it has to be noted that it is not possible to completely remove all volatile particles. Thus, “removing” here signifies the removal of a quantity of volatile particles—e.g., at least 90%—allowing for the measurement of the characteristic values, thereby enabling the correct analysis of sample gas flow in the subsequent sensor device 4.

As explained in more detail below, the standard volumetric flow through sensor device 4 and through removal device 3 is set by a flow-limiting device 5, e.g. a throttle device, although a pump 6 could also be used to to ensure a forced constant standard volumetric flow rate. Of course, the flow-limiting device 5 can also be installed in another place in the sample line 9, for example between removal device 3 and sensor device 4 or before the removal device 3 in the direction of flow. As is common knowledge, the standard volumetric flow rate is the volumetric flow rate under standard conditions of 0° C. and a pressure of 1013 mbar. Volumetric flow rate and standard volumetric flow rate can easily be converted using the general gas equation.

Removal device 3 comprises an evaporator 7 and a catalyst 8, as is shown in FIG. 2, with the catalyst 8 being installed downstream of evaporator 7. In evaporator 7 the sample gas is heated to a temperature T₁ of 150 to 400° C. to convert the volatile particles into the gas phase. Evaporator 7 may be implemented simply as a segment of the sample line 9 which is heated by a heating device 10. It is understood that this segment can also be thermally insulated on the outside by means of insulation 14 (see FIG. 4). Catalyst 8, too, may be heated by means of a heating device 11, preferably to a temperature T₂ of 150 to 400° C., preferably with T₂<T₁.

Catalyst 8 may be realized as an oxidation catalyst 12 or as a sulfur trap 13, FIG. 3a. However, catalyst 8 may also comprise an oxidation catalyst 12 and a sulfur trap 13 that can be arranged in any order one after the other, FIG. 3b. Oxidation catalyst 12 and sulfur trap 13 may be separate units, preferably they are integrated in a single unit, which results in a particularly compact catalyst 8. Oxidation catalyst 12 burns in a known manner the volatile organic particles that have been converted in the gas phase in evaporator 7. Sulfur trap 13 binds the volatile sulfatic particles, thus removing them from the sample gas. Design and manufacturing of such a catalyst 8 and in particular of an oxidation catalyst 12 and a sulfur trap 13 are well-known and will not be described in more detail here.

In a preferred embodiment evaporator 7 and catalyst 8 are installed in direct succession of each other, as shown in FIG. 4. A thermal insulation 15 may be arranged at the exit of removal device 3 and the removal device 3 can be fitted with a thermal insulation 14 too.

Catalyst 8 has a specific catalytic efficiency in the form of a maximum standard volumetric flow rate \dot{V} at which a sufficient functioning of catalyst 8 can still be ensured. Catalysts as currently available have a standard volumetric flow rate \dot{V} of about 1 to 5 l/min, for instance. When the standard volumetric flow rate \dot{V} through the removal device 3 is limited to this catalytic efficiency by the flow limiting device 5, no diluter needs to be installed before the removal device 3 and undiluted sample gas can directly be supplied. The standard volumetric flow rate \dot{V} can be limited manually or automatically by means of a suitable control device. At the same time, due to this limited standard volumetric flow rate \dot{V} no active cooling is necessary after the removal device 3. The passive convection cooling of sample line 9 to the environment is sufficient to sufficiently cool down the sample gas before it enters the sensor device 4. Only a few centimeters of sample line 9 suffice for that. In support of that, a cooling element 16 could be installed on sample line 9 after the removal device 3 to enlarge the cooling surface, e.g. as shown in FIG. 4 in the form of cooling ribs.

In a preferred, particularly compact embodiment according to FIG. 4, it is possible to realize overall lengths of the catalyst 8 in the range of some centimeters, for example 5-7 cm. The length of evaporator 7 may be in the range of 5-10 cm, the following convection segment of the sample line 9 could also be in the range of a few centimeters, for example 3-6 cm. This results in an extremely compact removal device 3.

As a result of this compact design and the resulting energy efficiency it may also be used for gas analysis in mobile applications, e.g. in moving vehicles.

A wide variety of sensors may be used for sensor device 4, e.g. a photo-acoustic soot measuring cell, stray light sensors, stray light photometers, condensation nuclei counters, diffusion charge sensors, optical particle counters, etc.

1. A device for the removal of volatile particles from an undiluted sample gas loaded with solid particles and volatile particles, wherein a removal device (3) comprising an evaporator (7) and a catalyst (8) is provided, with the catalyst (8) being arranged downstream of the evaporator (7), and that furthermore a flow limiting device (5) is provided which adjusts the standard volumetric flow rate (\dot{V}) of the undiluted sample gas to a predefined catalytic efficiency of the catalyst (8).

2. The device according to claim 1, wherein the evaporator (7) and the catalyst (8) are installed in direct succession of each other.

3. The device according to claim 1, wherein the flow limiting device (5) limits the standard volumetric flow rate (\dot{V}) to 1 to 5 l/min.

4. The device according to claim 1, wherein the catalyst (8) is realized as an oxidation catalyst (12).

5. The device according to claim 1, wherein the catalyst (8) is realized as a sulfur trap (13).

6. The device according to claim 1, wherein the catalyst (8) comprises an oxidation catalyst (12) and a sulfur trap (13).

7. The device according to claim 6, wherein the oxidation catalyst (12) and the sulfur trap (13) are installed in the catalyst (8) in an arbitrary order in direct succession of each other.

8. The use of the device according to claim 1 for the determination of a characteristic value of a gas flow loaded with particles in a mobile application.
